(19) United States
(12) Patent Application Publication
(10) Pub. No.: US 2019/0114046 A1
(43) Pub. Date: Apr. 18, 2019

(54) EVENT CALENDAR AND DOCUMENT EDITING WITH ADVANCED FEATURES AND INTEGRATED PERSONAL CLOUD MANAGER

(71) Applicant: Sgrouples, Inc., Mountain View, CA (US)

(72) Inventors: Mark WEINSTEIN, Mountain View, CA (US); Jason HARDY, Cedar Park, TX (US); Jonathan WOLFE, Albuquerque, NM (US)

(73) Assignee: Sgrouples, Inc., Mountain View, CA (US)

(21) Appl. No.: 16/160,911

(22) Filed: Oct. 15, 2018

Related U.S. Application Data
(60) Provisional application No. 62/572,546, filed on Oct. 15, 2017.

(51) Int. Cl. G06F 3/0484; G06F 3/0482; H04L 12/58

(52) U.S. Cl. CPC G06F 3/0484; H04L 51/046; H04L 51/08; G06F 3/0482

(57) ABSTRACT

A computer-implemented method communicates event information on a communication platform. The method comprises generating a calendar screen; and generating an event page in response to a user selection on the calendar screen.

### RELATED APPLICATIONS

This application claims the priority benefit of U.S. Provisional Application Ser. No. 62/572,546, filed Oct. 15, 2017. This application is related to U.S. non-provisional patent application Ser. No. 15/784,172, filed Oct. 15, 2017, entitled “Communication Platform With Advanced Features & Integrated Personal Cloud Manager,” which is incorporated by reference herein in its entirety.

### BACKGROUND

The disclosure relates to computer networks, electronic and other communication devices, wearables, virtual reality systems, and more particularly systems and methods related to social networking, enterprise communication software, and electronic/telecommunications.

Unless otherwise indicated herein, the approaches described in this section are not admitted to be prior art by inclusion in this section.

Conventional event software, features and functions, such as embodied by Facebook® Events and Google® Calendar provide a variety of features and uses that have advanced the state of the art of computer and technology based events. However, many problems and challenges remain, including means and methods by which to advance the methods and mechanisms by which people connect, communicate, organize, and share events.

### SUMMARY

The present disclosure provides for events and document editing with advanced features and integrated personal cloud manager. According to certain aspects, embodiments of the invention provide the advancement of events: an all-in-one dashboard that offers truly private one-to-one, one-to-many, collaborative events, social events, advanced features, document editing, personal cloud storage, and much more.

According to certain additional aspects, an embodiment of the invention is a web and mobile based application that allows users to upload and manage their digital content, and also to control how their content is shared with others in an event, via email, and in one-to-one, one-to-many, and other types of groupings and environments that they can create or be invited into. Many aspects of the service are new, including new features, new functionality, new ways of doing things; and many aspects of the service invent different as well as enhanced components, services, user experiences, etc.

In a user's private event environment, in addition to sharing their own content, they can also receive content from other event attendees who have enabled them to see it, and “reshare” it with others. The whole system is built on a powerful technologically advanced software with breakthrough visual, tactile, audio, and other technologies and software embodying permissions and sharing models that gives content owners/creators/sharers/recipients/respondents the ability to selectively share and to control the permissions that those viewers of the content have. Additionally, the user has their own personal document storage area sometimes called the “My Cloud” area which serves as a general repository and permissions manager for all the content they own, of whatever type. From My Cloud, the user may choose to share their content with others, to revoke the sharing of their content that they have previously shared, to change what they allow others to do with their content, to download it from the site, and if they wish, delete it entirely. Users may also receive content from and share content to external social networks that are accessible from within the communication platform environment.

The following detailed description and accompanying drawings provide a better understanding of the nature and advantages of the present disclosure.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, which describe various implementation examples of embodiments of the invention in a service accessed by a browser application on any known or future computing device. Those skilled in the art will understand how to implement the invention after being taught by the foregoing descriptions and drawings.

FIG. 1 illustrates a screenshot of an event dashboard according to some embodiments.

FIG. 2 illustrates a screenshot of an event page according to some embodiments.

FIGS. 3a and 3b illustrates a screenshot of event permissions according to some embodiments.

FIG. 4 illustrates a screenshot of an event photo stream according to some embodiments.

FIGS. 5a and 5b illustrates a screenshot of event albums and event #tags according to some embodiments.

FIG. 6 illustrates a screenshot of sharing an event post according to some embodiments.

FIG. 7 illustrates a screenshot of an event post according to some embodiments.

FIG. 8 illustrates a screenshot of auto creating an event according to some embodiments.

FIG. 9 illustrates a screenshot of an event hash tag feed according to some embodiments.

FIG. 10 illustrates a screenshot of an event chat according to some embodiments.

FIG. 11 illustrates a screenshot of a document service according to some embodiments.

FIG. 12 illustrates a screenshot of opening a chat over a document service according to some embodiments.

FIG. 13 illustrates a screenshot of accessing notifications over a document service according to some embodiments.

FIG. 14 illustrates a screenshot of collaborating on a post on top of a document according to some embodiments.

FIG. 15 illustrates the flow of using a document service according to some embodiments.

FIG. 16 illustrates the flow of using an event service according to some embodiments.

FIG. 17 illustrates the flow of using an event service according to some embodiments.

FIG. 18 illustrates a computer system according to some embodiments.

### DETAILED DESCRIPTION

### Event Calendar

Reference in the specification to “one embodiment”, “an embodiment”, “various embodiments” or “some embodiments” means that a particular feature, structure, or characteristic described in connection with these embodiments is included in at least one embodiment of the invention, and such references in various places in the specification are not necessarily all referring to the same embodiment.

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

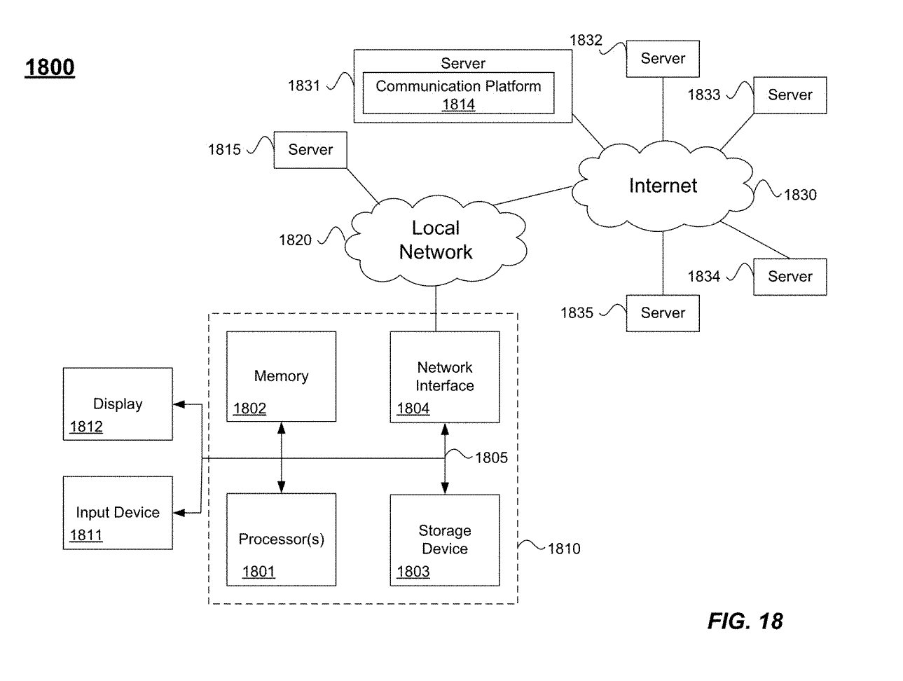

FIG. 18 illustrates a computer system 1800 according to some embodiments. Computer system 1800 comprises a computer system 1810, Computer system 1810 can send and receive information, including messages or other interface actions, through the network interface 1804 across a local network 1820, an Intranet, or the Internet 1830. For a local network, computer system 1810 may communicate with a plurality of other computer machines, such as server 1815. Accordingly, computer system 1810 and server computer systems represented by server 1815 may form a cloud computing network, which may be programmed with processes described herein. In the Internet example, software components or services may reside on multiple different computer systems 1810 or servers 1831-1835 across the network. The processes described herein may be implemented on one or more servers, for example. A server 1831 may transmit actions or messages from one component, through Internet 1830, local network 1820, and network interface 1804 to a component on computer system 1810. The software components and processes described herein may be implemented on any computer system and send and/or receive information across a network, for example.

One or more of servers 1831-1835 include a communication platform 1814 that provides a private as well as open social and communication technology platform and an integrated personal cloud manager. Communication platform 1814 may include a cloud storage (described below as My Cloud) for users, and a database for the data for all features described herein.

FIG. 18 is described further below.

Communication platform 1814 may include, or may be used with or in the social platforms described in US Published Patent Application No. US 20150149282 A1, published May 28, 2015 “Social platform with enhanced privacy and integrated customization features,” which is incorporated herein by reference in its entirety. Communication platform 1814 may include, or may be used with or in the social platforms described in U.S. non-provisional patent application Ser. No. 15/784,172, filed Oct. 15, 2017, entitled “Communication Platform With Advanced Features & Integrated Personal Cloud Manager,” which is incorporated by reference herein in its entirety.

Example aspects of these and other features and advantages will be described in more detail below. These descriptions will refer to an example platform, in which all of the above services and features are integrated. However, the invention is not limited to this particular example platform and/or combination of services and features, as will be appreciated by those skilled in the art after being taught by the following examples.

In general, embodiments of the invention provide a number of different features and advantages that advance the state of the art of events and calendars. These features and advantages are provided via a combination of one or more services including:
1) Event page
2) Event chat
3) Event photo stream and photo albums
4) Event posts
5) Instant events from text in chat
6) Event permissions
7) Hash tags in events
8) Event content connected to the user's personal cloud storage

### 1. Event Page

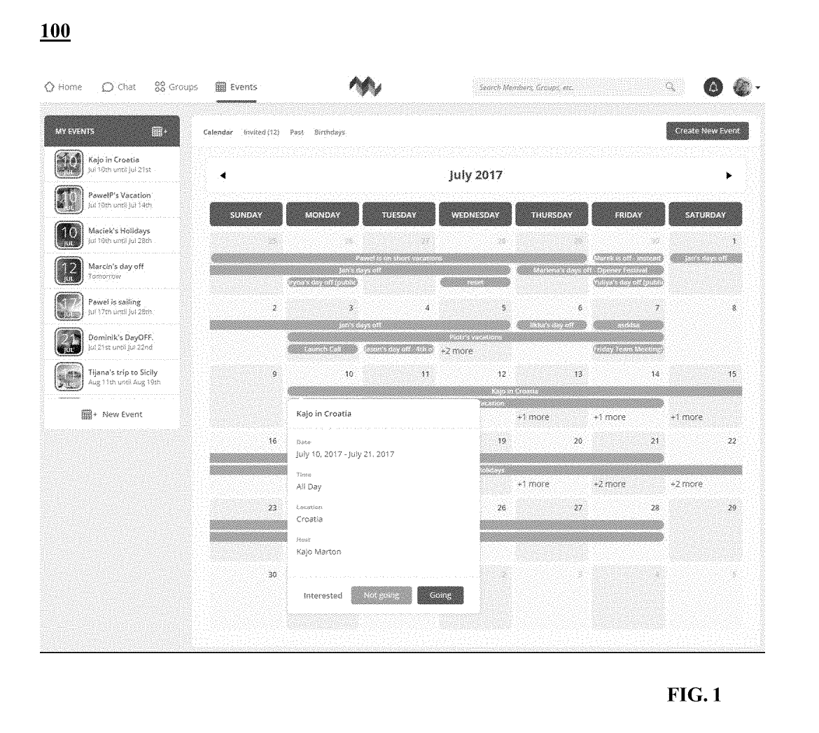

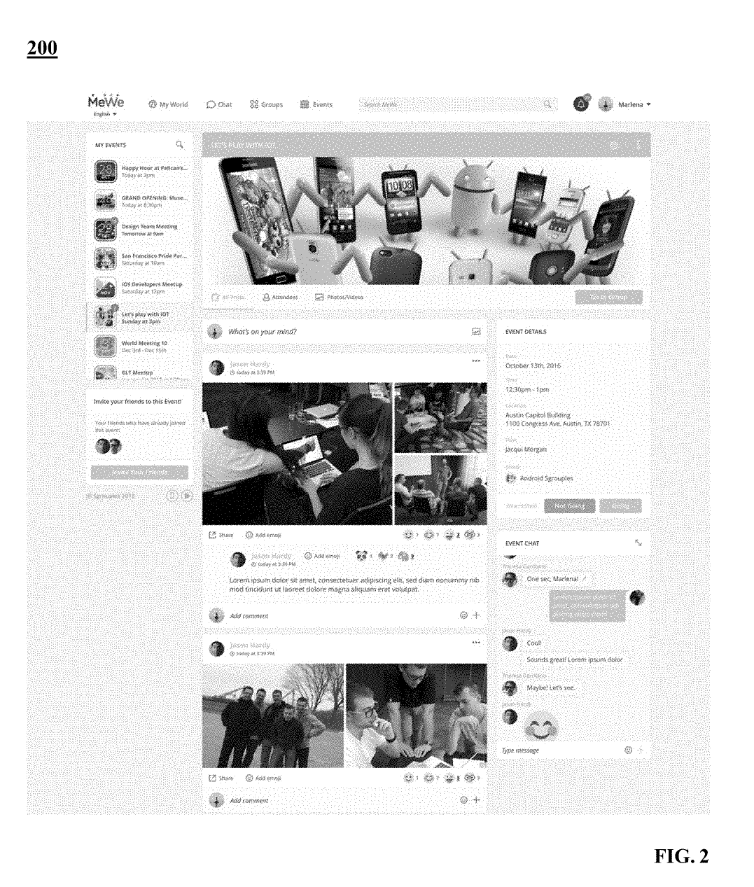

FIG. 1 illustrates a screenshot 100 of an event dashboard according to some embodiments. FIG. 2 illustrates a screenshot 200 of an event page according to some embodiments. Every event has a dedicated page with a unique cover photo. The event page is a dashboard that displays quick access to all of the event content. On the even page there is an overview of the event details, all posts, who is attending, event chat, event settings and event information.

### 2. Event Chat

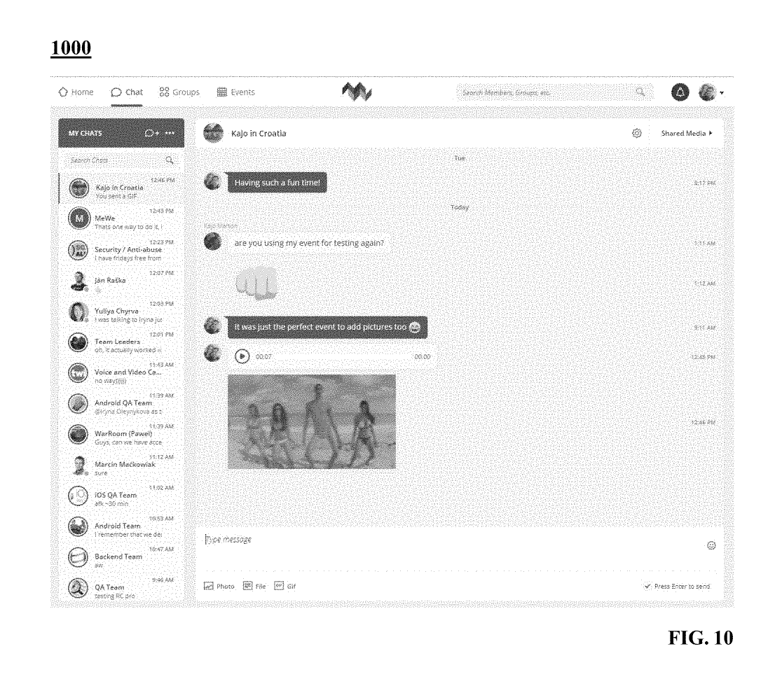

FIG. 10 illustrates a screenshot 1000 of an event chat according to some embodiments. To streamline communication and make managing events easier, every event has a dedicated chat thread for all attendees. This is an optional feature for all attendees and if an attendee does not want to participate in an event chat there is the option to hide the event chat for each event. In addition, the host, creator of the event, has the option to turn off event chat for all event attendees.

Event chats are integrated into the user's list of chats just like all other types of chat as shown in fig. All photos shared in the event chat are put in the event page photo stream and the user's personal cloud manager. The user can access the event chat on the event page and from their list of chats on the chat page. Event chat allows for real time communication with event attendee's in addition to asynchronous messaging via event posts.

In addition to sending text, photos, and video inside event chat the user can also send voice messages in the event chat. Posting with voice/audio can be combined with pictures, video, links, documents, text and all other current and future communication technology mediums as well as in virtual reality contexts.

All attendees are automatically added or removed from the event chat based on their status of going or not going to the event

### 3. Event Photo Stream and Photo Albums

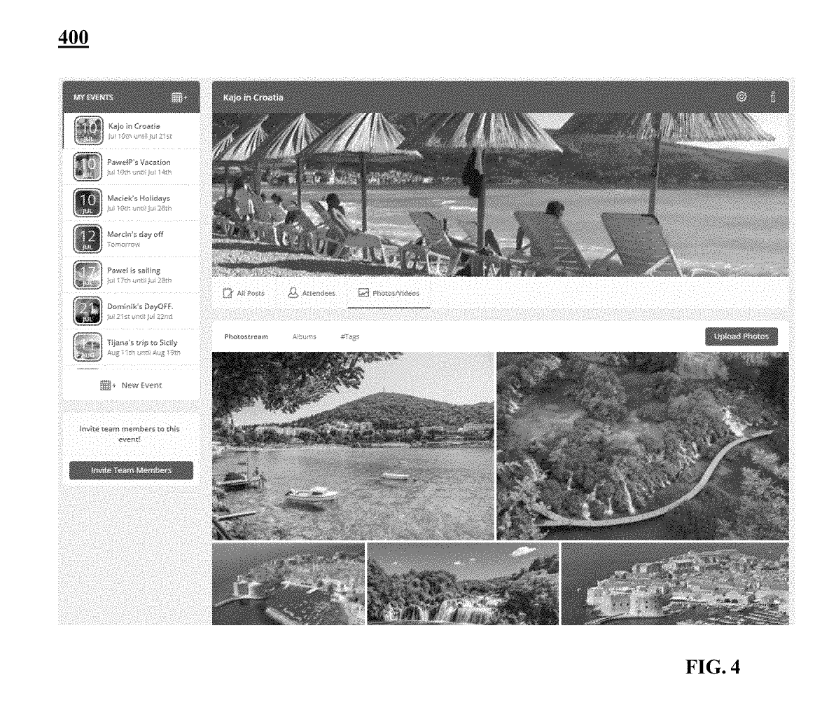

FIG. 4 illustrates a screenshot 400 of an event photo stream according to some embodiments. The event photo stream displays all of the photos and videos that have ever been shared or uploaded to the event by all attendees. Photos, videos, and files can be uploaded using the postbox, chatbox or a direct upload on the file and photo tabs. The layout of how the photos are displayed may be designed to highlight both vertical and horizontal photos. The User Interface may include two drop down menus, a list and grid view option, upload photos option and create album option.

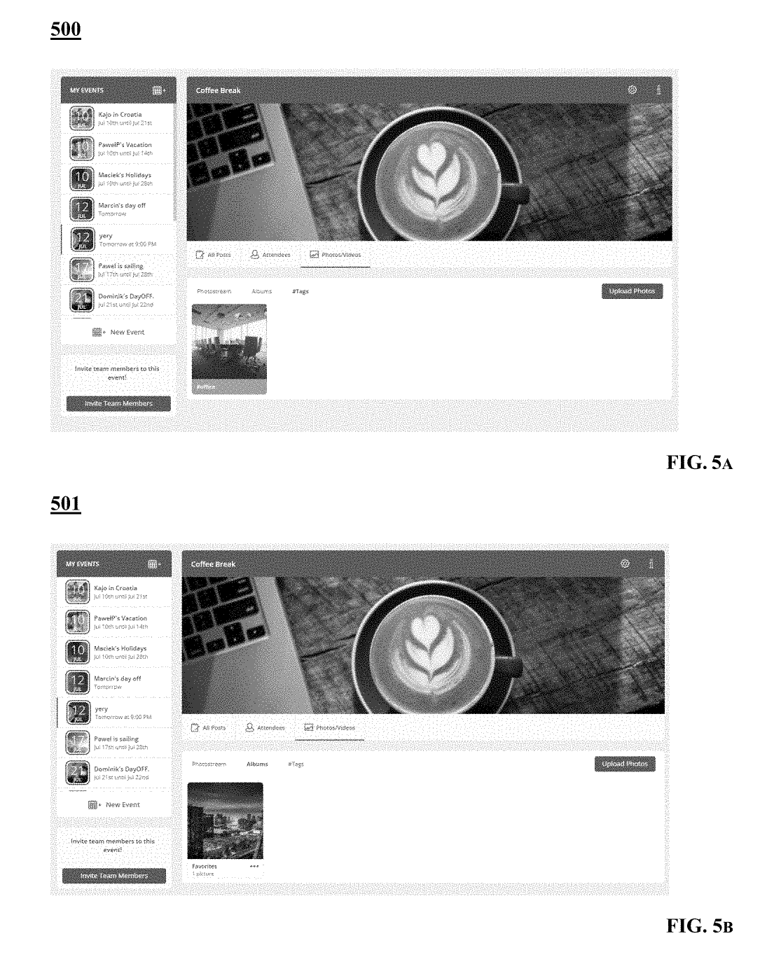

FIGS. 5a and 5b illustrates screenshots 500 and 550, respectively, of event albums and event #tags according to some embodiments. Any event photo or video shared or uploaded to the event can be added to a new or existing photo album. All event attendees can add photos or videos to the event photo albums.

### 4. Event Post

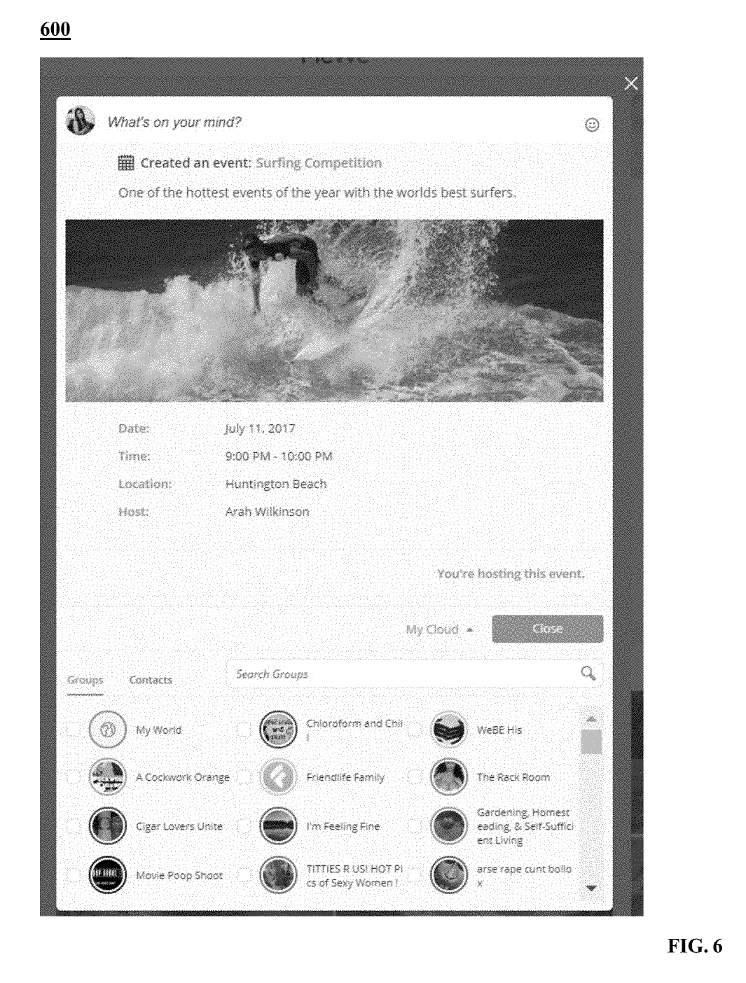

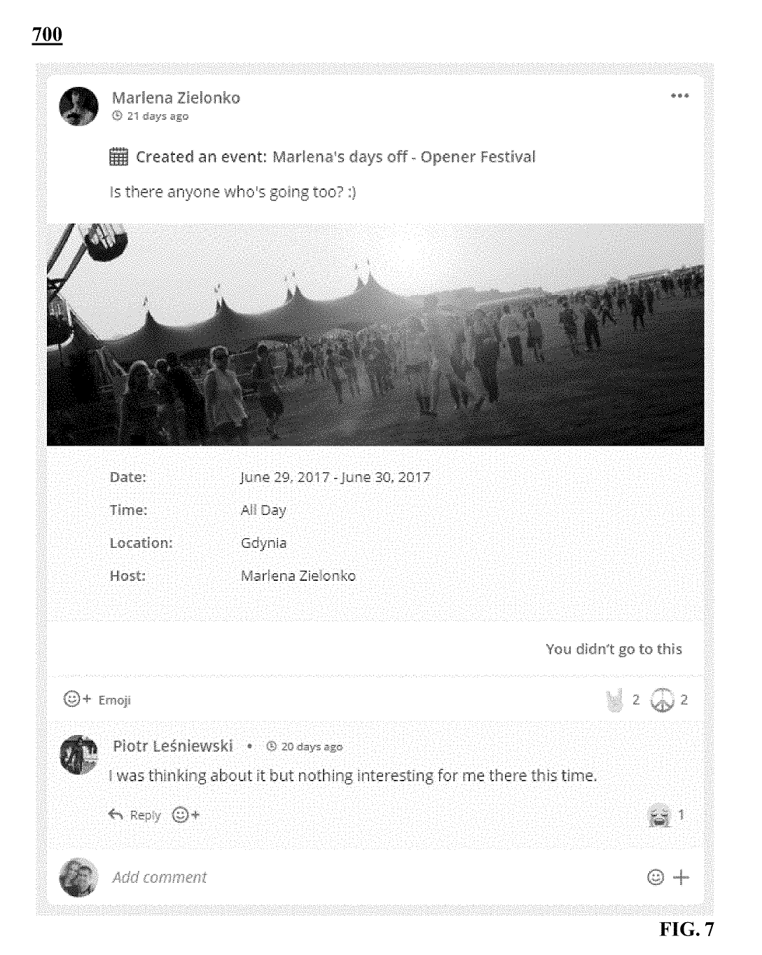

FIGS. 6 and 7 illustrates screenshots 600 and 700, respectively, of an event post according to some embodiments. When an open event is created there is the option to create an event post so that the user can share this event post to the user's contacts and/or groups. This post can be shared by other members to help spread the word about this open event. Users can comment on event posts and emoji event posts.

### 5. Create an Event from Text in Chat

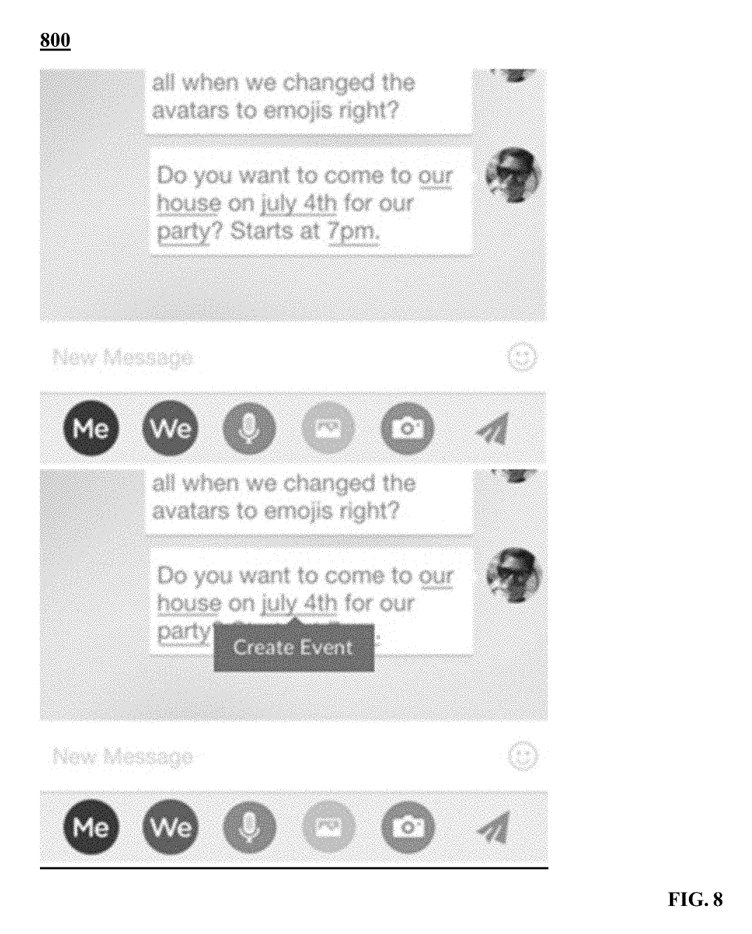

FIG. 8 illustrates a screenshot 800 of auto creating an event according to some embodiments. The user can instantly create a private event with 1 or several people by clicking on a chat message that contains certain keywords. Key words will be underlined in the chat message and if clicked on the underlined text will create a prompt to create an event and then start the event creation flow from there, with the appropriate fields already filled in.

Some of the keywords are: today, tomorrow, next week, this week, next Saturday (Sunday/Monday/etc.), next Saturday (Sun/Mon/Tues/etc.), this Saturday (Sunday/Monday/etc.), this Saturday (Sun/Mon/Tues/etc.), this weekend, next weekend, any timestamp variation (1, 1 pm, 1:00, 1:00 pm, 01:00 pm, 13:00, etc.), any variation in time (1 hour, 5 minutes, 3 days,) or place (here, there,) or subject (meeting, party, get together, hangout, come over, play, date, meet, great, meal, lunch, dinner, etc.)

### 6. Event Permissions

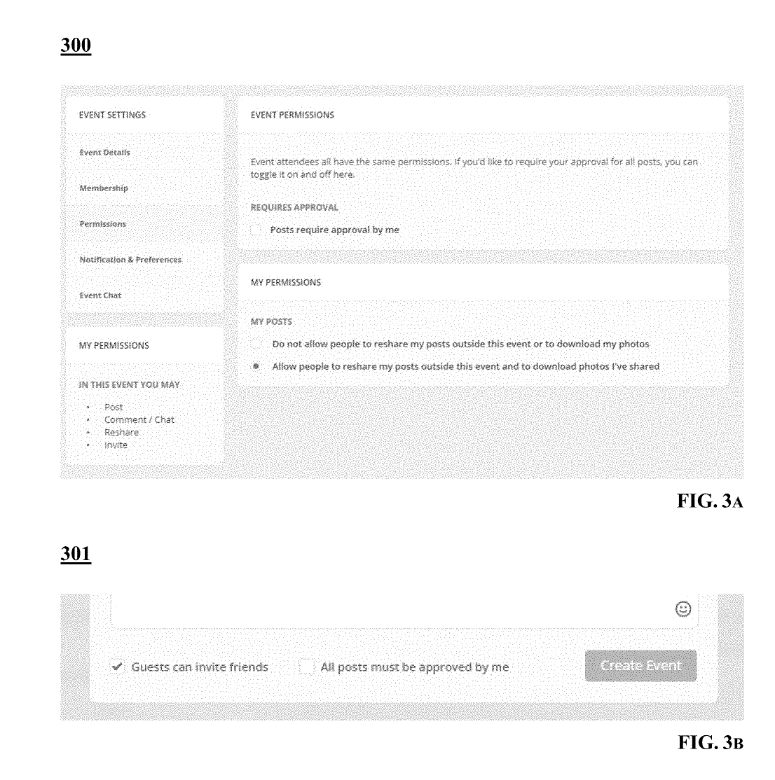

FIGS. 3a and 3b illustrates a screenshot 300 of event permissions according to some embodiments. Inside each event there is a permission option to set “all posts must be approved by me” which if selected will make it so that prior to event attendees seeing a post the user must first approve it. Once approved it will then show all the attendees the approved post. If disapproved, then the post will be deleted and no one attending the event will see this post.

Inside private events there is a permission option to set “guests can invite friends” which if selected will make it so anyone attending an event can invite other members to the event. If this permission is turned off then only the host can invite members to the event.

FIGS. 3A and 3B illustrate screenshots 300 and 301 which show that inside each event the user can customize the user's permissions to have different privacy levels. The user can make it so event attendees are allowed to reshare the user's event posts and download the user's event photos or make it so event attendees are not allowed to reshare the user's event posts and download the user's event photos. In addition, the event host can decide if they want each post created to require approval by the host before sending it to all group attendees, as shown in FIGS. 3A and 3B.

### 7. Hash Tags

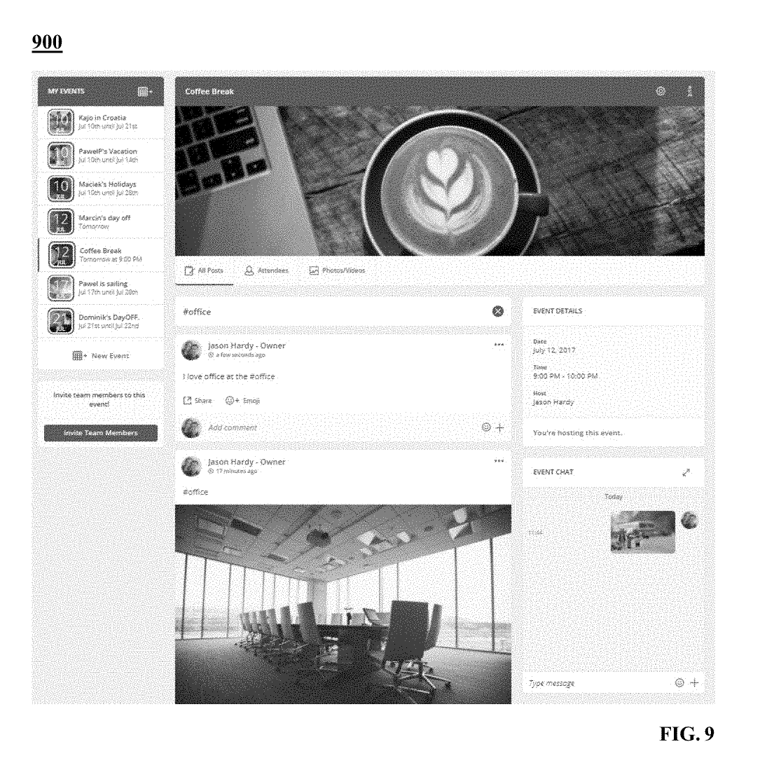

FIG. 9 illustrates a screenshot 900 of an event hash tag feed according to some embodiments. The user can hash tag content inside the user's event to make it easier to find and sort content. There are several ways that hash tags can be applied to events. For example, different content in an event post can be organized, sorted or filtered using hash tags or other signaling/flagging/tagging mechanisms that span across content types. For example, a user could find or follow a hash tag in an event and find photos, videos, voice messages, documents, etc. associated with that hash tag. The scope of use of these signaling/flagging/tagging mechanisms such as employing hash tags can be as narrow as the participants in event; alternatively it can be expanded to include content shared by other group members or contacts.

### 8. Event Content is Connected to the User's Personal Cloud Storage

My Cloud is a place to store everything a member has, owns, has shared, may share in the future, stores, owns digitally and is optimized to share content with others. My Cloud automatically saves all communications that a user has made on the service and everywhere in other social media, on other communication technology services and hardware, etc., that a user has specified.

All content, photos, videos, files and posts that a user shares to an event are automatically added to the users My Cloud.

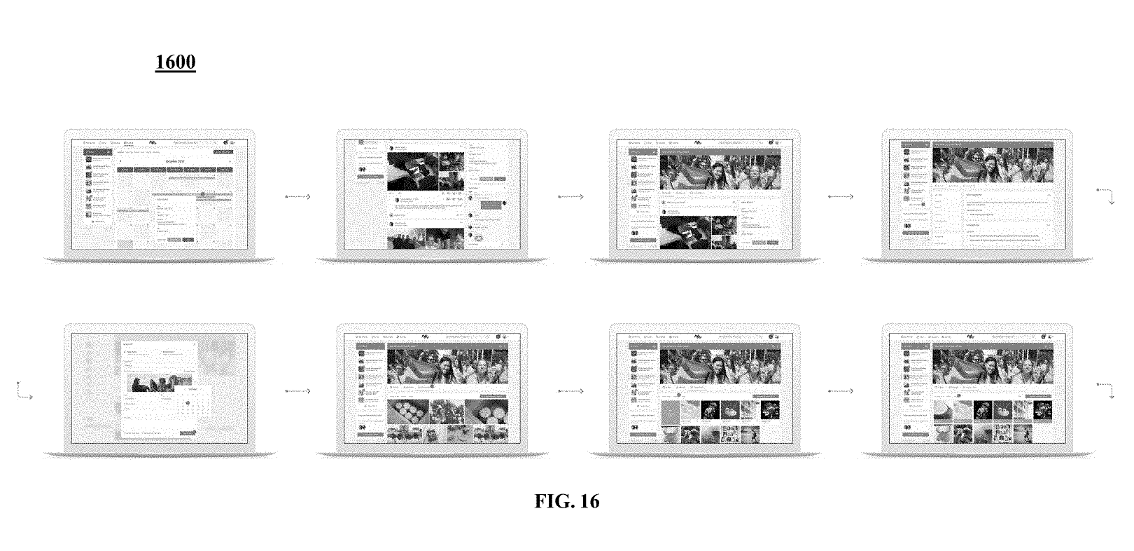

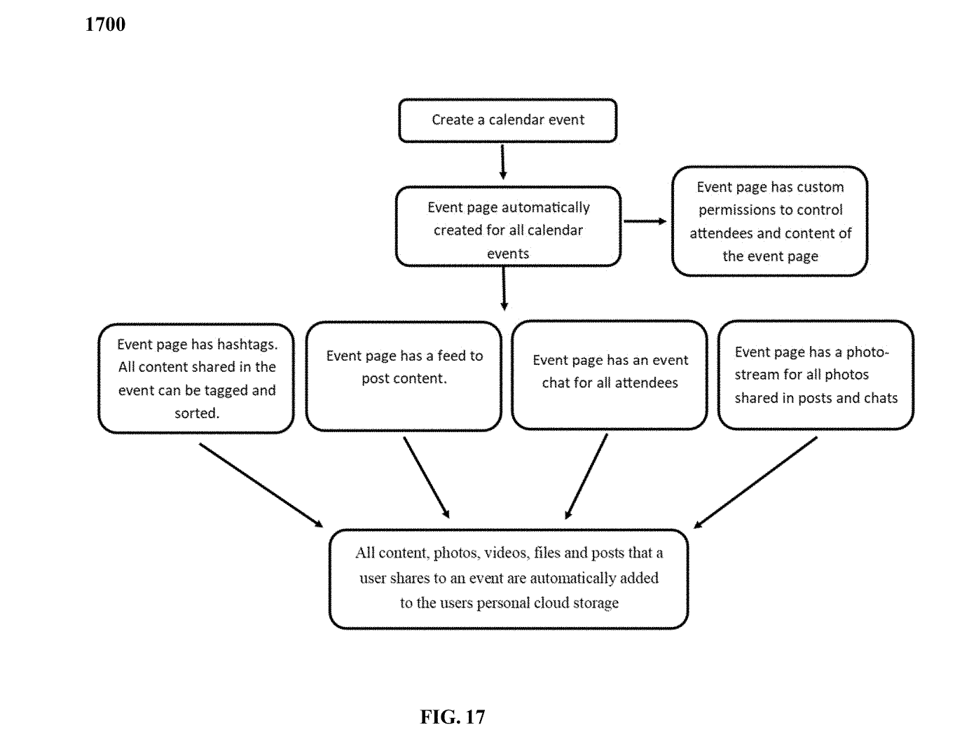

FIG. 16 illustrates the flow 1600 of using an event service according to some embodiments. FIG. 17 illustrates the flow 1700 of using an event service according to some embodiments. Communication platform 1814 processes the creation of a calendar event in response to a user command. Communication platform 1814 automatically creates an event page for all calendar events. In some embodiments, communication platform 1814 applies custom permissions (e.g., user selected or administrator selected) to control attendees and content of the event page. In some embodiments, communication platform 1814 includes hashtags on an event page. Communication platform 1814 allows a user to tag and sort any or all content shared in the event page. Communication platform 1814 includes a feed in the event page for posting content. Communication platform 1814 includes an event chat in the event page for any or all attendees. Communication platform 1814 includes a photostream in the event page for all photos shared in posts and chats. Communication platform 1814 automatically adds all content, photos, videos, files and posts that are user shares to an event to the user's personal cloud storage.

### Document Editing and Integration

In general, embodiments of the invention provide a number of different features and advantages that advance the state of document editing and integration. These features and advantages are provided via a combination of one or more services including:
1) Full document integration that allows using multiple services on a single browser tab. This means the document collaboration can happen inside the social platform without opening a second application or window.
2) Opening multiple chat windows on the same screen that the user is editing documents. This allows you to use the social platform chat and collaborate on a document without opening a second application or window
3) The ability to receive notifications and collaborate all while editing a document or navigating to a new page

### 1. Full Document Integration that Allows Using Multiple Services on One Browser Tab

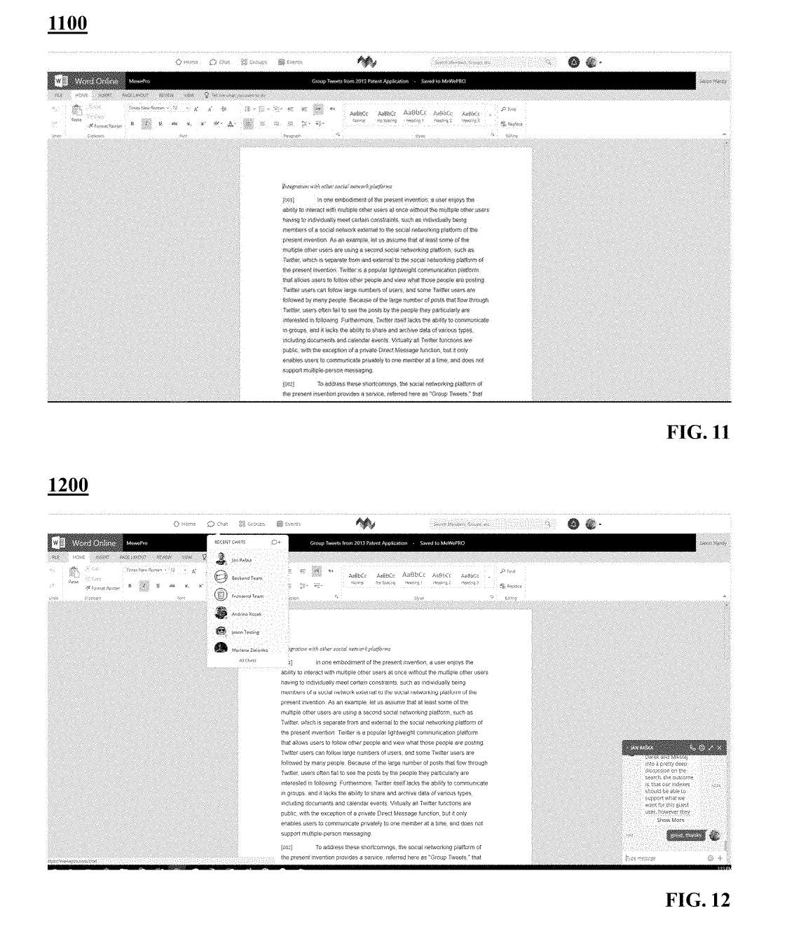

FIG. 11 illustrates a screenshot 1100 of a document editing service fully integrated into collaboration and communication software according to some embodiments. Conventional online document services only allow a user to focus on one thing, editing or viewing a document. With the document integration, a user can edit or view a document without leaving the platform so the user can still use all of the communication and collaboration tools without opening a new browser window.

### 2. Opening Multiple Chat Windows on the Same Screen that You are Editing Documents

FIG. 12 illustrates a screenshot 1200 of opening a chat window while editing a document according to some embodiments. To streamline communication and make collaborating on a document more efficient the user can open up multiple chat windows on top of a document that is being viewed or edited. In addition to sending text, photos, and video inside the chat the user can also send voice messages in the chat. Posting with voice/audio can be combined with pictures, video, links, documents, text and all other current and future communication technology mediums as well as in virtual reality contexts.

### 3. The Ability to Receive Notifications and Collaborate all While Editing a Document or Navigating to a New Page

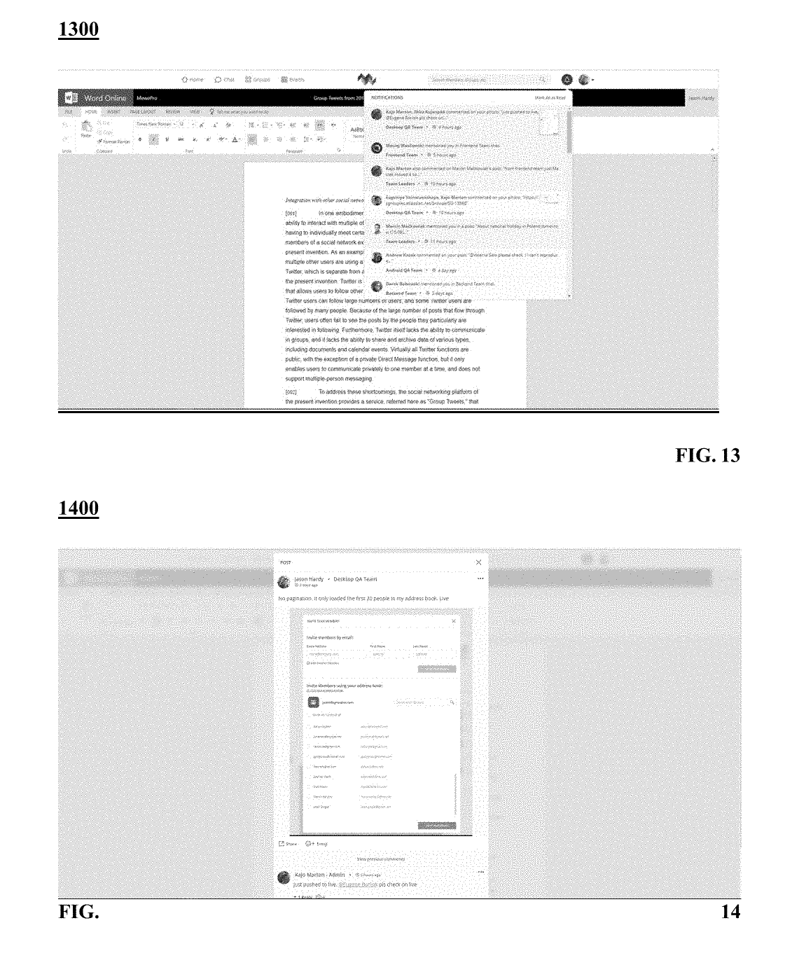

FIGS. 13 and 14 illustrates screenshots 1300 and 1400, respectively, of opening a notification and collaborating on a post while editing or viewing a document according to some embodiments. To be more efficient and productive our advanced document integration allows a user to collaborate on multiple forms of communication at once without having to navigate away from viewing or editing a document.

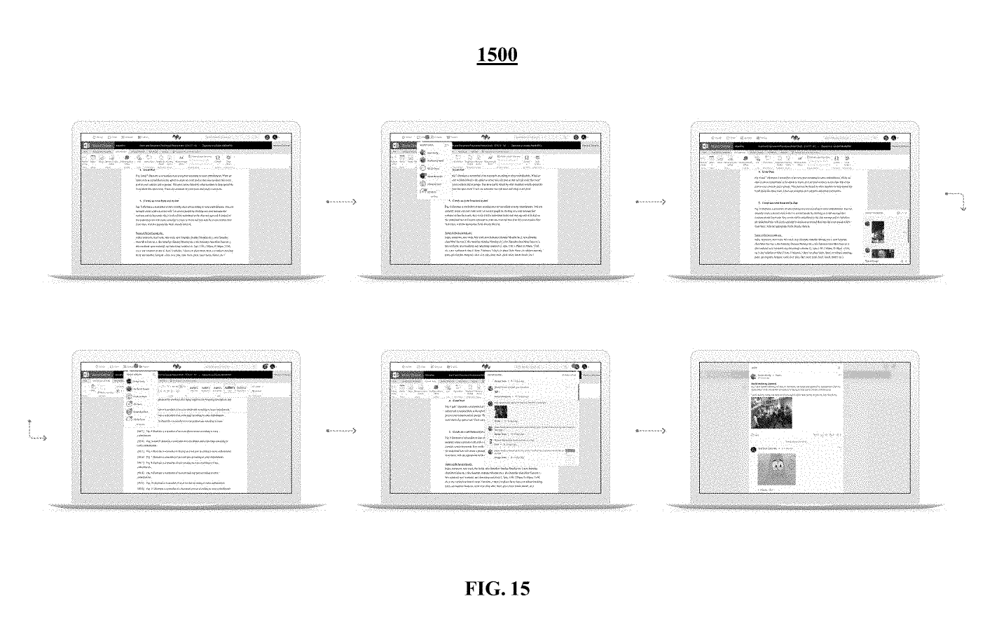

FIG. 15 illustrates the flow 1500 of using a document service according to some embodiments. A screenshot shows a document. A screenshot shows a dropdown menu for recent chats. After selecting a chat, communication platform 1814 opens and display the chat in the screenshot with the document. A screenshot shows a dropdown menu for groups. A screenshot shows a dropdown menu of notification. A screenshot shows a post.

What is claimed is:

1. A computer-implemented method for communicating on a communication platform, the method comprising:
generating a calendar screen; and
generating an event page in response to a user selection on the calendar screen.

2. The method of claim 1 further comprising:
generating an event chat user interface in response to a user selection.

3. The method of claim 3 wherein the event chat user interface is in the event page.

4. The method of claim 1 further comprising:
generating an event photo stream in response to a user selection; and
generating a photo album from photos in the event photo stream.

5. The method of claim 1 further comprising:
generating a user interface including event posts in response to a user selection.

6. The method of claim 5 further comprising:
providing the event posts to other users in response to a user selection.

7. The method of claim 1 further comprising:
generating instant events from text in a chat.

8. The method of claim 7 wherein generating instant events from text in a chat comprises:
opening a new event page in response to a user selection of content in the chat.

9. The method of claim 7 wherein generating instant events from text in a chat comprises:
generating a prompt window for a new event in response to a user selection of content in the chat.

10. The method of claim 8 wherein the user selection of content is a selection of a keyword.

11. The method of claim 7 further comprising:
displaying selected words of the chat as underlined words; and
generating the new event page with the selected words filled in a form on the new event page.

12. The method of claim 1 further comprising:
allowing access by another user to information associated with an event in response to a user selection of event permissions.

13. The method of claim 1 further comprising:
generating hash tags in the event page in response to a user selection.

14. The method of claim 13 further comprising:
sorting data in the event page based on a selected hash tag.

15. The method of claim 1 further comprising:
providing user event content to a cloud storage associated with said user.

16. A non-transitory computer readable storage medium storing one or more programs, the one or more programs comprising instructions for:
generating a calendar screen; and
generating an event page in response to a user selection on the calendar screen.

17. A computer system comprising:
a processor; and
a non-transitory computer readable medium having stored thereon one or more programs, which when executed by the processor, causes the processor execute instructions for:
generating a calendar screen; and
generating an event page in response to a user selection on the calendar screen.
